(19) United States
(12) Patent Application Publication
(10) Pub. No.: US 2014/0236743 A1
(43) Pub. Date: Aug. 21, 2014

(54) ORDER INPUT APPARATUS AND METHOD FOR EXECUTING SETTLEMENT PROCESSING AT TABLE

(71) Applicant: TOSHIBA TEC KABUSHIKI KAISHA, Tokyo (JP)

(72) Inventor: Hideo Kobayashi, Shizuoka-ken (JP)

(73) Assignee: TOSHIBA TEC KABUSHIKI KAISHA, Tokyo (JP)

(21) Appl. No.: 14/174,977

(22) Filed: Feb. 7, 2014

(30) Foreign Application Priority Data
Feb. 18, 2013 (JP) 2013-029025

(51) Int. Cl. G06Q 50/12; G06Q 20/32

(52) U.S. Cl. CPC G06Q 50/12; G06Q 20/327
USPC 705/15

(57) ABSTRACT

An order input apparatus which receives input of an order information according to an order and the order information is managed with a management apparatus, comprises a short distance wireless communication section configured to establish a wireless communication with a medium adapted for an electronic settlement at a short distance; a checkout information calling module configured to call a desired checkout information relating to the order information from the management apparatus; a settlement declaration module configured to declare a settlement on the checkout information; a settlement module configured to execute a settlement processing for the checkout information through the electronic settlement with the medium the communication of which is established with the short distance wireless communication section; and an update module configured to inform the management apparatus of the information relating to the settlement with the settlement module to update the checkout information.

### CROSS-REFERENCE TO RELATED APPLICATION

This application is based upon and claims the benefit of priority from Japanese Patent Application No. 2013-029025, filed Feb. 18, 2013, the entire contents of which are incorporated herein by reference.

### FIELD

Embodiments described herein relate to an order input apparatus and method for executing a settlement processing at a table.

### BACKGROUND

For example, a processing apparatus is used in a lot of restaurants such as a casual dining restaurant and a pub to execute a processing relating to various operations including a reception work for an order on menu items, a checkout work and the like. In such a processing apparatus, input operation by a user such as a shop clerk is received in an order input apparatus, and a processing corresponding to the input operation is executed.

Specifically, in the use of a system in a restaurant, the aforementioned order input apparatus and processing apparatus correspond to, for example, an order entry terminal and a station (server), respectively. Moreover, in this case, a person in charge of receiving an order inputs the menu items ordered by a customer. The order entry terminal generates order information containing a list of menu items ordered with the input operation and sends the generated order information to the station. The station creates a cooking instruction slip and carries out a sales management processing based on the order information.

### BRIEF DESCRIPTION OF THE DRAWINGS

FIG. 1 is a system configuration diagram illustrating the configuration of an order processing system according to an embodiment;

FIG. 2 is a plan view illustrating the external appearance of an order entry terminal;

FIG. 3 is a block diagram illustrating the hardware arrangement of the order entry terminal;

FIG. 4 is a block diagram illustrating the functions relating to the data processing of the order entry terminal;

FIG. 5 is a flowchart illustrating the flow of a table settlement processing;

FIG. 6 is a diagram illustrating an example of the screens transition in the table settlement processing;

FIG. 7 is a plan view illustrating an example of a checkout slip for a POS; and

FIG. 8 is a plan view illustrating an example of a checkout receipt.

### DETAILED DESCRIPTION

In accordance with an embodiment, an order input apparatus, which receives input of an order information according to an order and the order information is managed with a management apparatus, comprises a short distance wireless communication section configured to establish a wireless communication with a medium adapted for an electronic settlement at a short distance, a checkout information calling module, a settlement declaration module, a settlement module and an update module. The checkout information calling module calls a desired checkout information relating to the order information from the management apparatus. The settlement declaration module declares a settlement on the checkout information. The settlement module executes a settlement processing for the checkout information, the settlement on which is declared by the settlement declaration module, through the electronic settlement with the medium the communication of which is established with the short distance wireless communication section. The update module informs the management apparatus of the information relating to the settlement with the settlement module to update the checkout information to information ‘settled’.

An embodiment is described below with reference to the accompanying drawings.

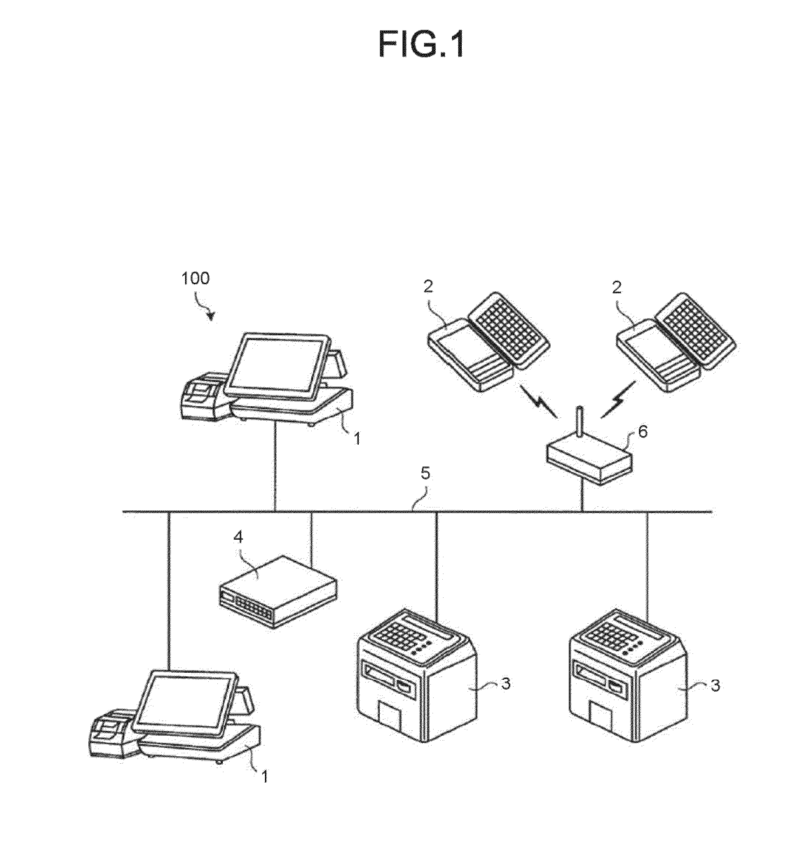

FIG. 1 is a system configuration diagram illustrating the configuration of an order processing system 100 according to an embodiment. The order processing system 100 can be used in a facility, such as a restaurant and a store, where a food service or commodity sales service is offered according to an order of a customer. In the present embodiment, the order processing system 100 is described below as an apparatus appropriate to be used in a restaurant.

In the order processing system 100, a plurality of information terminals 1, a plurality of order entry terminals 2, a plurality of slip printers 3 and a station 4 is connected with a LAN (Local Area Network) 5, respectively. However, the order entry terminals 2 are connected with the LAN 5 via a wireless access point 6. Although each terminal 1, 2 and the slip printer 3 are respectively shown at two in FIG. 1, the number of the elements may be set, optionally. The number of the information terminals 1, the order terminals 2 or the slip printers 3 may be one.

The information terminals 1 are PCs (Personal Computer) or POS (Point of Sales) terminals and the like which are arranged, for example, on a service floor for customer or a checkout counter. The information terminal 1 carries out processing relating to various operations including a customer guidance work, an order reception work, a waiting (serving) work or a checkout work. Moreover, the processing relating to the guidance work, the order reception work and the waiting (serving) work are mainly used in the information terminal 1 arranged on the service floor for customer. On the other hand, the processing relating to the checkout work is used in the information terminal 1 arranged on a checkout counter. The information terminal 1 may also be set as an apparatus specialized for a specific purpose to merely carry out processing relating to part of the aforementioned operations.

The order entry terminal 2 includes a user interface provided with a plurality of operation keys and functions as an order input apparatus which receives input of the order information relating to an order through a user operation carried out via the user interface. The order entry terminal 2 generates order information according to the input operation and wirelessly sends the generated order information. The order information wirelessly sent from the order entry terminal 2 is transmitted to the station 4 via the wireless access point 6 and the LAN 5.

The station 4 is arranged, for example, in a backyard, and functions as a management apparatus for carrying out a totalizing processing for various kinds of information (order information, checkout information relating to the order information and the like) sent from the information terminal 1 and a processing relating to the management work relative to business of a restaurant. Further, the station 4 manages information commonly shared in the plurality of information terminals 1.

The slip printer 3 is arranged, for example, at the service floor for customer or at a kitchen. The slip printer 3 arranged at the service floor prints an order slip for a customer according to the order information. Therefore, the slip printer 3 arranged at the service floor is used as a so-called customer printer. On the other hand, the slip printer 3 arranged at a kitchen prints a cooking instruction slip for a cook according to the order information. The slip printer 3 arranged at a kitchen is used as a so-called kitchen printer.

Generally, in the order processing system 100, when a user operates the information terminal 1 or the order entry terminal 2 to input an order, the order information which is generated in the information terminal 1 or the order entry terminal 2 according to the operation is transmitted to the station 4 via the LAN 5. For the sake of a checkout processing or a totalizing processing and the like, the station 4 manages the received order information. Further, the station 4 sends the order information to the slip printer 3 via the LAN 5. The slip printer 3 prints a cooking instruction slip or an order slip according to the content corresponding to the received order information.

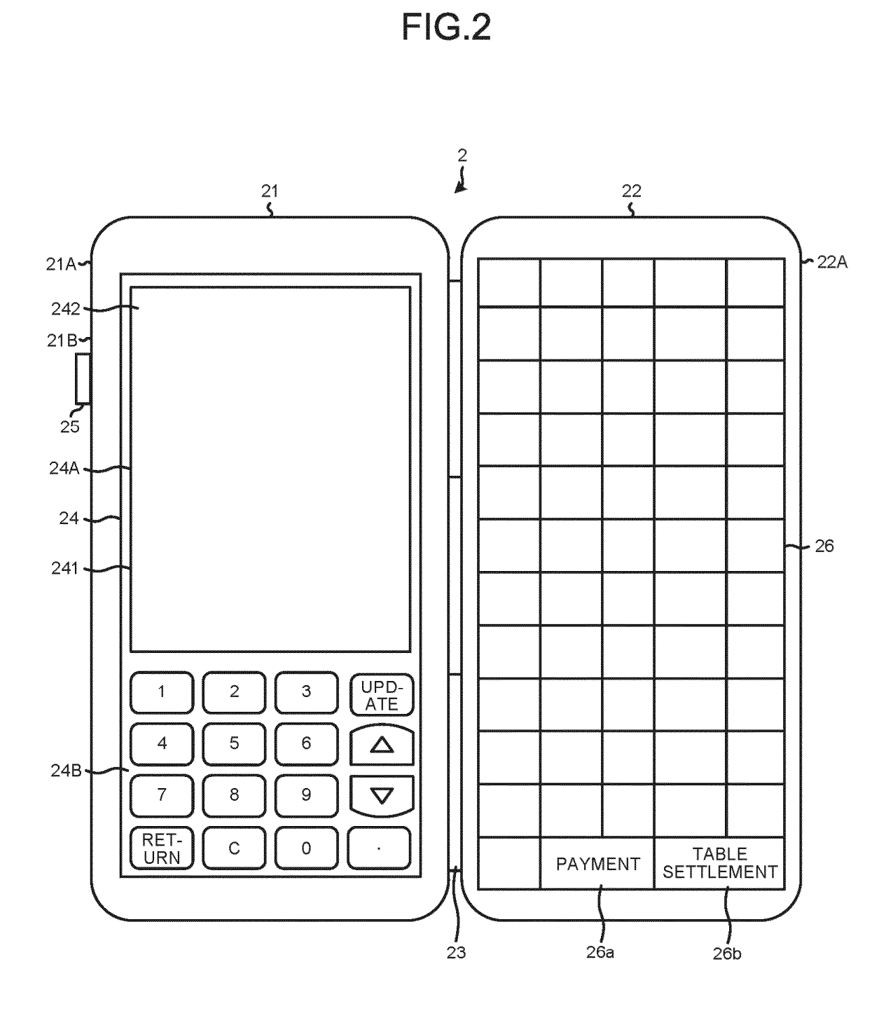

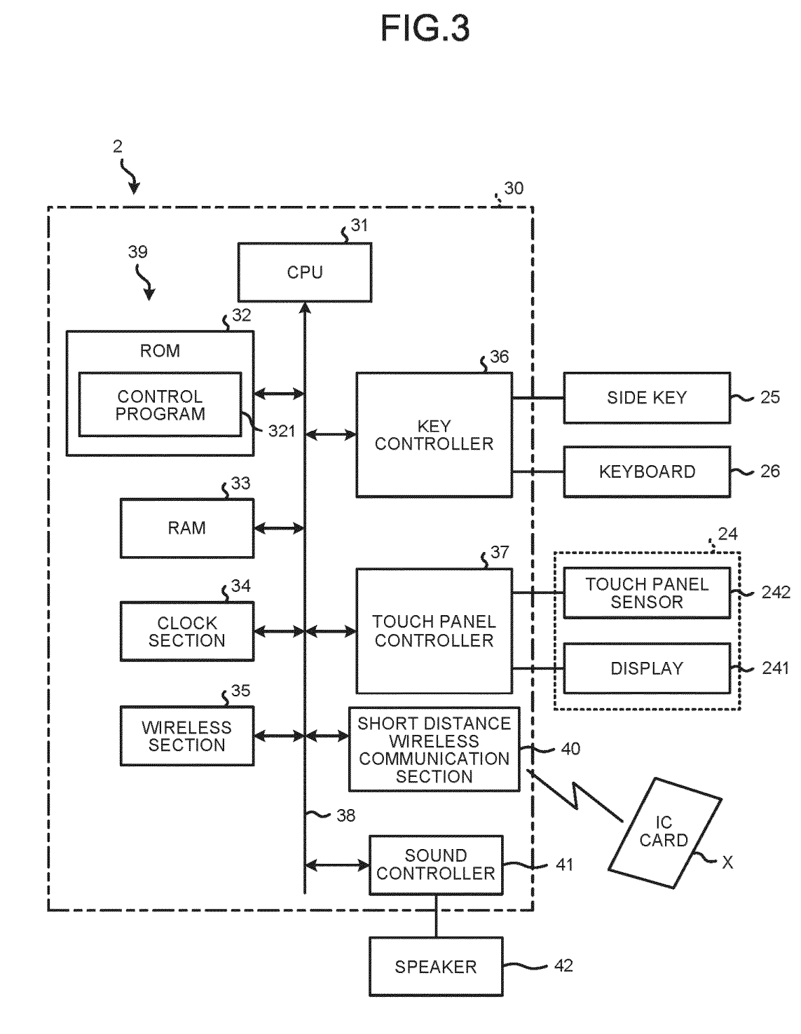

The order entry terminal 2 is described next. FIG. 2 is a plan view illustrating the external appearance of the order entry terminal 2, and FIG. 3 is a block diagram illustrating the hardware arrangement of the order entry terminal 2.

As shown in FIG. 2, the order entry terminal 2 comprises a first component 21 arranged at left hand side and a second component 22 arranged at right hand side in a two-page spread manner, as a portable main body. The first component 21 and the second component 22 are both in a roughly rectangular parallelepiped shape. The second component 22 is connected with the first component 21 in a freely rotational manner via a fastener 23 such as a hinge and the like. The second component 22 is rotatable between the opened state (FIG. 2) and the closed state (not shown) with respect to the first component 21 around the fastener 23.

A touch panel 24 acting as a display operation section is arranged on a surface 21A of the first component 21 externally exposed in the opened state. Further, a side key 25 is arranged on the left side face 21B shown in FIG. 2. A membrane keyboard 26 is arranged on a surface 22A of the second component 22 externally exposed in the opened state.

The touch panel 24 has a touch panel sensor 242, serving as an operation section, which is overlaid on the screen of a liquid crystal display (hereinafter referred to as a display 241 serving as a display section and is divided into a display input section 24A and a numeric keypad section 24B. A screen data described later is displayed on the display input section 24A. On the numeric keypad section 24B, a ‘Return’ key, a ‘C’ (clear) key , an ‘Update’ key, ‘Δ’ (up) and ‘∇’ (down) keys and a ‘.’ (decimal point) key are arranged as well as numeric keys.

A plurality of fixed keys on which characters and outlines are printed in a matrix form are arranged on the membrane keyboard 26. The membrane keyboard 26 is featured in resistance to stains such as dirt or liquid in comparison with other keyboards. Functions supporting an order work are assigned to the fixed keys, respectively.

Further, in the embodiment, a payment key 26a for declaring calling of checkout information in a table settlement processing described later and a table settlement key 26b for declaring the settlement of the table settlement processing are also arranged on the keyboard 26 of the order entry terminal 2.

A control board 30 is arranged in either of the first and second components 21 and 22 of the order entry terminal 2. A microcomputer 39 for driving and controlling other components are included in the control board 30, as shown in FIG. 3. The microcomputer 39 is constructed in such a manner that a CPU (Central Processing Unit) 31 for controlling other components intensively is connected with a ROM (Read Only Memory) 32 and a RAM (Random Access Memory) 33 via a bus line 38 such as an address bus, a data bus and the like. The microcomputer 39 with the above structure is connected with a clock section 34, a wireless section 35, a key controller 36, a touch panel controller 37, a short distance wireless communication section 40 and a sound controller 41 via the bus line 38.

The ROM 32 is a nonvolatile memory capable of maintaining information or data even if power is off and functions as a storage section for storing a fixed data such as programs including a control program 321 and a menu data such as a setting data for menu items, an out-of-stock data of menu items and the like.

The RAM 33 temporarily stores a variable data such as a screen data displayed on the display 241, a data sent to the station 4 and the like. The clock section 34 keeps time to generate current date and time.

The wireless section 35 includes a wireless communication section for controlling data transmission/reception with the wireless access point 6 and is a wireless communication device for executing wireless communication in accordance with, for example, the IEEE 802.11 standard.

The key controller 36 monitors the side key 25 and each fixed key on the keyboard 26 to determine whether or not there is a key input. The touch panel controller 37 controls the screen displayed on the display 241 of the touch panel 24. Further, the touch panel controller 37 detects the two-dimensional coordinates of a touch position on the screen through a signal of the touch panel sensor 242.

The short distance wireless communication section 40 is a known NFC (Near Field Communication) device used as an interface which carries out communication with, for example, an IC card X wirelessly with a small-power wireless communication technology at a short distance from zero to several centimeters. The IC card X is a well-known medium in which an Integrated Circuit (IC) including a storage device such as a semiconductor memory and the like is incorporated and which has a short distance wireless communication function.

The IC card X adapts, for example, to an electronic settlement service with an electronic money and the like.

The sound controller 41 is a sound source device which outputs the audio data to a speaker 42.

Next, the table settlement processing by the order entry terminal 2 among the various processing executed by the microcomputer 39 (CPU 31) of the order entry terminal 2 according to the control program 321 is described below.

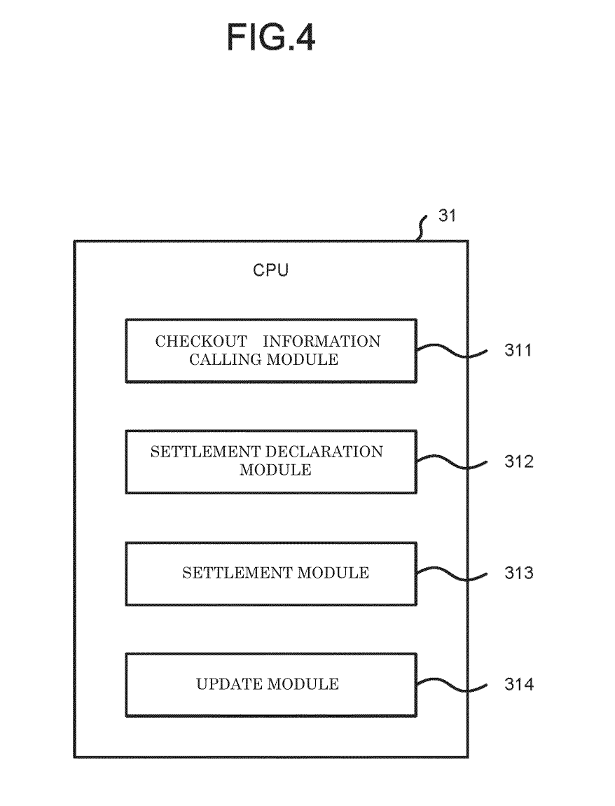

FIG. 4 is a block diagram illustrating the functions relating to the table settlement processing carried out by the microcomputer 39 (CPU 31) of the order entry terminal 2. As shown in FIG. 4, the CPU 31 of the order entry terminal 2 operates according to the control program 321 to function as a checkout information calling module 311, a settlement declaration module 312, a settlement module 313 and an update module 314.

The checkout information calling module 311 calls the checkout information relating to the order information from the station 4 serving as a management apparatus. The settlement declaration module 312 declares a settlement for the checkout information.

The settlement module 313 executes a settlement processing for the checkout information the settlement of which is declared by the settlement declaration module 312 through an electronic settlement on which the communication with the IC card X is established by the short distance wireless communication section 40.

The update module 314 informs the station 4 of the information relating to the settlement by the settlement module 313 and updates the checkout information to information ‘settled’.

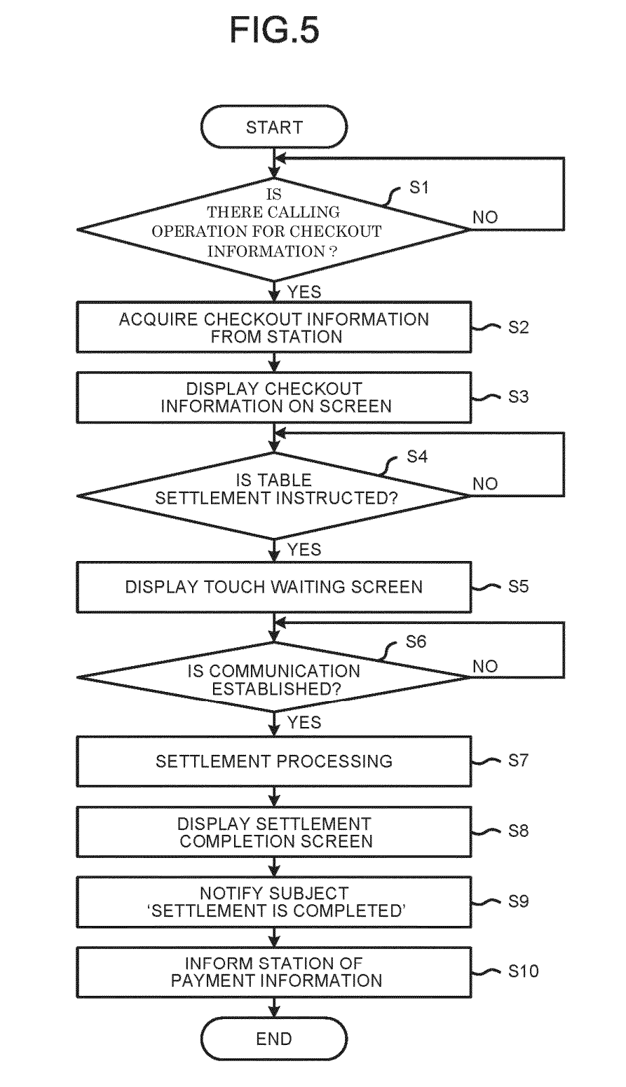

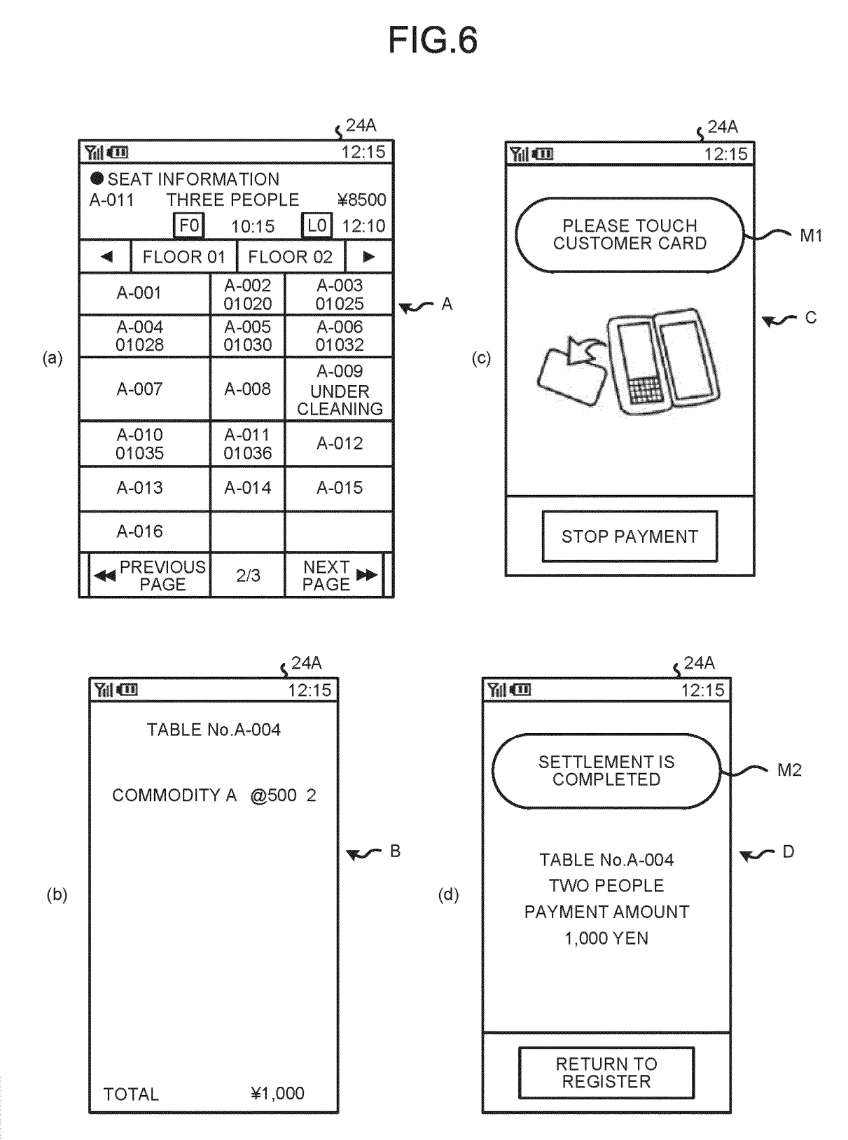

Next, the flow of the table settlement processing of the order entry terminal 2 is described with reference to the flowchart of FIG. 5 and the example of the screen transition shown in FIG. 6.

As shown in the flowchart of FIG. 5, the CPU 31 (checkout information calling module 311) of the order entry terminal 2 waits for the calling operation on checkout information (ACT S1) in a state that the seat information screen A shown in FIG. 6(a) is displayed on the display input section 24A of the display 241 of the order entry terminal 2. The seat information screen A enables a customer who desires to carryout a table settlement in which a checkout processing is executed while sitting at the table to select a table number.

When a hall staff touches the table number to which a table settlement is executed on the seat information screen A and operates the payment key 26a on the keyboard 26 of the order entry terminal 2, the CPU 31 (checkout information calling module 311) of the order entry terminal 2 determines that a calling operation for checkout information is carried out (YES in ACT S1) and inquires the station 4 to acquire checkout information containing details of the settlement and a payment amount (ACT S2).

Next, the CPU 31 (checkout information calling module 311) of the order entry terminal 2 displays the checkout information screen B as shown in FIG. 6 (b) on the display input section 24A of the display 241 (ACT S3) based on the checkout information acquired in ACT S2. The checkout information screen B shown in FIG. 6 (b) is an example of a screen on which the checkout information (details and payment amount) of the table No. A-004 is displayed.

In the present embodiment, the checkout information of a customer who desires a table settlement is selected with the table number, however, the present embodiment is not limited to this case, and the checkout information may also be selected with a slip number.

The checkout information on the checkout information screen B acquired in the aforementioned way is confirmed by the hall staff. After confirming the checkout information on the checkout information screen B, the hall staff operates the table settlement key 26b on the keyboard 26 of the order entry terminal 2.

Next, as shown in the flowchart of FIG. 5, if it is determined that a table settlement is instructed (YES in ACT S4) by the operation on the table settlement key 26b on the keyboard 26 of the order entry terminal 2 by the hall staff, the CPU 31 (settlement declaration module 312) of the order entry terminal 2 displays the touch waiting screen C, shown in FIG. 6(c), on the display input section 24A of the display 241 of the order entry terminal 2 (ACT S5).

A message M1 ‘Please touch your customer card’ is displayed on the touch waiting screen C shown in FIG. 6(c) . In this way, the hall staff serving as an operator is urged to establish a communication with an IC card X adapted for an electronic settlement service with an electronic money.

Thus, in the state of displaying the touch waiting screen C, the order terminal 2 closes to an IC card X, as shown in the flowchart of FIG. 5. Then, if it is determined that the communication between the short distance wireless communication section 40 and the IC card X is established (YES in ACT S6), the CPU 31 (settlement module 313) of the order entry terminal 2 executes the settlement processing (ACT S7). Then the CPU 31 displays the settlement completion screen D shown in FIG. 6(d) on the display input section 24A of the display 241 of the order entry terminal 2 (ACT S8) and informs completion of the settlement with a notification method other than the display of a message (ACT S9).

As shown in FIG. 6(d), a message M2 ‘settlement is completed’ is displayed on the settlement completion screen D. In this way, the customer who requests the table settlement and the hall staff are informed of completion of the settlement carried out with the IC card X through an electronic settlement service.

As an example of the notification method, audio data or message ‘settlement is completed’ is prepared in advance and output to the speaker 42 from the sound controller 41. The present embodiment is not limited to this case, and a notification with LEDs that message information is received, or a notification with vibrator that message information is received may also be adopted.

Next, as shown in the flowchart of FIG. 5, the CPU 31 (update module 314) of the order entry terminal 2 informs the station 4 of the payment information (ACT S10).

The station 4 updates the checkout information to information ‘settled’ based on the informed payment information and issues a POS checkout slip through the slip printer 3 which is used as a customer printer.

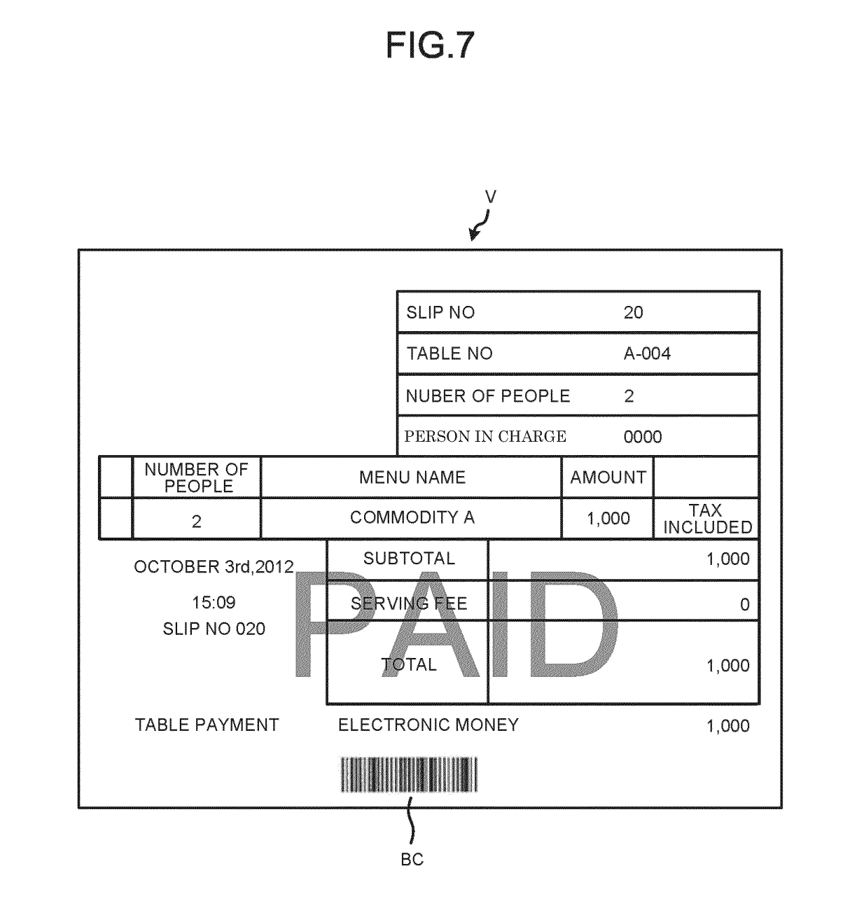

FIG. 7 is a plan view illustrating an example of a checkout slip V with POS. As shown in FIG. 7, in addition to a slip number and a table number, the price of each menu item contained in the checkout information in the table settlement and the total amount of each menu item are also printed on the checkout slip V. Further, on the checkout slip V, a row at which information ‘table payment: electronic money’ representing the completion of the table settlement with electronic money is printed is arranged below a row at which ‘Total’ is printed. Further, a character ‘paid’ in watermark is printed on the checkout slip V. Moreover, a barcode BC for calling a slip is also printed on the checkout slip V. The barcode BC for calling a slip represents, for example, a slip number which is used to confirm the checkout information stored in the station 4 through a scanning operation during a settlement.

The hall staff hands the checkout slip V issued in this way to the customer who requests the table settlement. Then, the customer takes the delivered checkout slip V to the checkout counter. At the checkout counter, the cashier scans the barcode BC for calling the checkout slip V with the scanner (not shown) of the information terminal 1 to acquire a slip number, for example.

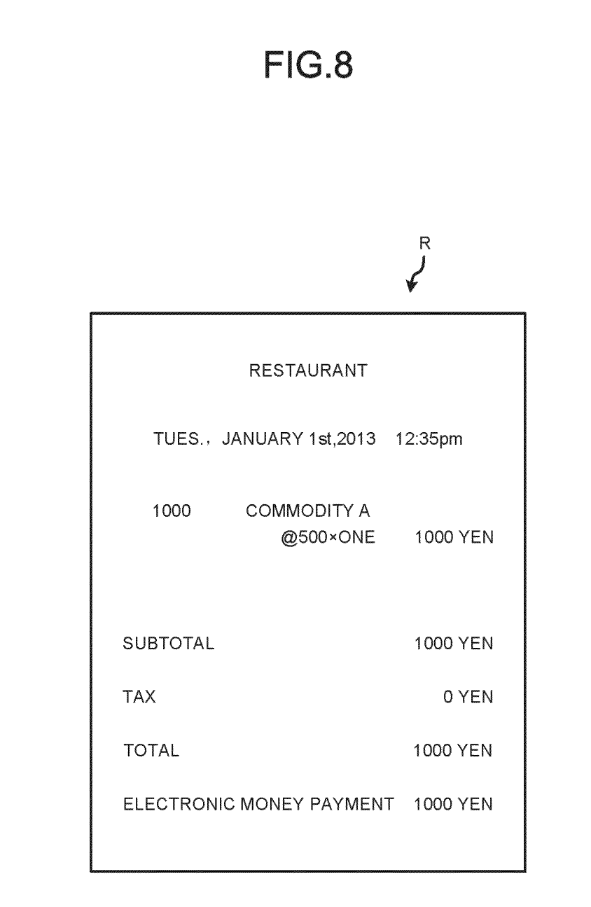

The information terminal 1 sends the read barcode data (e.g. slip number) to the station 4 and confirms the checkout information stored in the station 4. If the table settlement is carried out as described above and the checkout information is updated to information ‘settled’, then checkout information and information ‘settled’ are notified to the information terminal 1 from the station 4. When a notice including the checkout information and the information ‘settled’ is received from the station 4, the information terminal 1 outputs a checkout receipt R shown in FIG. 8 according to the checkout information and terminates the checkout processing. As shown in FIG. 8, on the checkout receipt R, a row at which information ‘paid with electronic money’ representing the completion of a payment with electronic money is printed is arranged below a row at which character ‘Total’ is printed.

Further, the hall staff may also carry a small-sized portable printer (not shown) previously to carryout a checkout processing in which a signal instructing the issuing of a checkout receipt R is output to the portable printer from the station 4 which informs of payment information as if the checkout processing is executed in the information terminal 1 without issuing the checkout slip V from the slip printer in the way described in the present embodiment.

In this way, according to the present embodiment, the order entry terminal 2 calls the checkout information relating to the order information from the station 4 to execute a settlement processing based on the checkout information through an electronic settlement with an IC card X, adapted for an electronic settlement service with electronic money, the communication of which is established with the short distance wireless communication section 40, and informs the station 4 of the information relating to the settlement to update the checkout information to information ‘settled’. Thus, the checkout work can be performed with the order entry terminal 2 while the customer sits at the restaurant table after having food and drink.

The control program 321 executed by the order entry terminal in this embodiment may be provided by storing in a computer-readable recording medium such as a CD-ROM, a FD (flexible disk) , a CD-R, a DVD (digital versatile disk) as a file in an installable or executable form.

Further, the control program 321 executed by the order entry terminal 2 in this embodiment may be stored in a computer connected with a network such as the Internet to be provided through downloading via the network, or provided or distributed via the network.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An order input apparatus which receives input of an order information according to an order and the order information is managed with a management apparatus, comprising:
a short distance wireless communication section configured to establish a wireless communication with a medium adapted for an electronic settlement at a short distance;
a checkout information calling module configured to call a desired checkout information relating to the order information from the management apparatus;
a settlement declaration module configured to declare a settlement on the checkout information;
a settlement module configured to execute a settlement processing for the checkout information, the settlement on which is declared by the settlement declaration module, through the electronic settlement with the medium the communication of which is established with the short distance wireless communication section; and
an update module configured to inform the management apparatus of the information relating to the settlement with the settlement module to update the checkout information.

2. The order input apparatus according to claim 1, wherein the settlement module further includes a notification module configured to notify a case in which the settlement processing is completed through the electronic settlement with the medium.

3. The order input apparatus according to claim 1, further comprising a keyboard on which functions for supporting the input of order information relating to the order are allocated, wherein
the checkout information calling module calls the checkout information from the management apparatus if it is determined that an operation on a payment key allocated on the keyboard is performed.

4. The order input apparatus according to claim 3, wherein the settlement declaration module declares a settlement on the checkout information if it is determined that the operation on the settlement key allocated on the keyboard is performed.

5. The order input apparatus according to claim 1, further comprising a display section configured to display various screens, wherein
the settlement module displays a message for urging the establishment of the communication with the medium on the display section and executes the settlement processing through the electronic settlement with the medium if the communication with the medium is established by the short distance wireless communication section.

6. A method for executing a settlement processing through an electronic settlement with a medium which is adapted to the electronic settlement at a table, comprising:
calling a checkout information relating to an order information;
declaring a settlement on the checkout information;
executing the settlement processing for the checkout information the settlement on which is declared through the electronic settlement with the medium the communication of which is established;
notifying information relating to the settlement declared to a management apparatus; and
updating the checkout information in the management apparatus.
